(19) United States
(12) Patent Application Publication
(10) Pub. No.: US 2025/0377460 A1
(43) Pub. Date: Dec. 11, 2025

(54) INFORMATION CARRIER FOR PROVIDING INFORMATION TO A LIDAR SENSOR

(71) Applicant: Flasheye AB, Kiruna (SE)

(72) Inventor: Ulf Lindström, Kiruna (SE)

(21) Appl. No.: 18/878,538

(22) PCT Filed: Jun. 9, 2023
(86) PCT No.: PCT/EP2023/065546

§ 371 Date: Dec. 23, 2024

(30) Foreign Application Priority Data
Jun. 29, 2022 (SE) 2250812-1

(51) Int. Cl. G01S 17/89; G01S 7/48; G06T 7/521; G06V 20/52

(52) U.S. Cl. CPC G01S 17/89; G01S 7/4802; G06T 7/521; G06V 20/52; G06T 2207/10028; G06T 2207/30196; G06V 2201/06; G06V 2201/07

(57) ABSTRACT

An information carrier for providing information to a LIDAR sensor and a method for configuring a monitoring system by using the information carrier. The information carrier comprises a sheet formed code carrier having a first reflectivity, and at least one code pattern on a part of one side of the sheet formed code carrier. The code pattern comprises first code areas in the form of apertures through the sheet formed code carrier, and second code areas having a second reflectivity, wherein the code areas are arranged according to a predetermined regular pattern, and wherein the code areas are at a distance from each other with the code carrier between the code areas.

### TECHNICAL FIELD

The present invention relates to an information carrier for providing information to a LIDAR sensor. The present invention also relates to a method for configuring a monitoring system using said information carrier, wherein the monitoring system comprises at least one LIDAR sensor.

### BACKGROUND ART

In order to avoid damage to persons it is desirable to make sure that people do not come close to the machines when they are in operation. Directive 2006/42/EC—“New machinery directive” defines what has to be fulfilled for safe operation of automatic machines. Known techniques to solve this problem includes the arrangement of physical barriers around the automatic machines such as, e.g., cages, which are often arranged around industrial robots. However, such physical barriers complicates necessary service and repairs. An alternative to physical barriers is digital barriers such as photocell-barriers or the like, which are connected to a control device, which shuts down the machine if any one passes a digital barrier. Around a larger machine such as a conveyor belt, it might be necessary with many separate digital barriers.

An alternative to digital barriers as described above is to monitor the entire area around an automatic machine with a digital imaging device connected to a computer. By analyzing the digital image, it is possible to monitor several of the above parameters. One of the problems with such monitoring is that it is difficult, time-consuming and therefore expensive to define what parts of the digital image that should be monitored.

There are other examples on monitoring apart from the example above.

The use of an optically detectable code for configuring a monitoring zone is described in US 2009/0015663 which describes a method and system for configuring a monitoring device for monitoring a spatial area. Setup marks, which are detectable by cameras, are used to configure the monitoring zone.

LIDAR is a well-established technique for detection of 3 dimensional objects. LIDAR may also be used for reading information from marker devices. U.S. Pat. No. 10,145,993B1 describes retroreflective marker devices, which encode information that can be read by optical sensors such as LIDAR. US2019220717A1 describes retroreflective multiscale codes, which can be read by optical sensors such as LIDAR.

When using markers to define the parts of the digital image that should be monitored it is important that the probability for erroneous reading of a code is minimized. A single point of failure may result in accidents.

When the marker devices and codes of the prior art are placed in an environment in which contamination may occur the probability of a correct reading of the code on the marker device may decrease due to contamination of the code, as contamination may result in a changed reflectivity of some areas.

### SUMMARY OF THE INVENTION

An object of the present invention is to provide an information carrier for providing information to a LIDAR sensor with which information carrier a high information density is provided.

Another object of the present invention is to provide an information carrier for providing information to a LIDAR sensor with which information carrier the probability is minimized for a failure in the detection of the code with a LIDAR sensor.

Another object of the present invention is to provide a method for configuring a monitoring system, wherein the monitoring system comprises at least one LIDAR sensor, wherein the method provides for a higher security in the configuration of the monitoring system.

The above objects are fulfilled with an information carrier and a method according to the independent claims.

Further advantages are provided with the features of the dependent claims.

According to a first aspect an information carrier for providing information to a LIDAR sensor, is provided. The information carrier comprises a sheet formed code carrier having a first reflectivity, and at least one code pattern on a part of one side of the sheet formed code carrier. The information carrier is characterized in that the code pattern comprises first code areas in the form of apertures through the sheet formed code carrier, and second code areas having a second reflectivity. The code areas are arranged according to a predetermined regular pattern, and wherein the code areas are at a distance from each other with the code carrier between the code areas.

The use of first code areas in the form of apertures through the sheet formed code carrier means that such code areas are not easily deteriorated by dirt, as no surface is present for dirt to stick onto. This means that the first code areas may be reliably detected almost irrespective of the conditions in which the code carrier is arranged. In other words, apertures are openings in the sheet formed code carrier, i.e., the apertures form holes through the sheet formed code carrier.

Reflectivity is a measure of the ability of a surface to reflect radiation, equal to the reflectance of a layer of material sufficiently thick for the reflectance not to depend on the thickness. Reflectivity is measured in percentage of the incident radiation. Thus, a first reflectivity is per definition different from a second reflectivity. The reflectivity may be the same in many different code areas as is indicated in the definition of the first aspect above where it is said that the second code areas have a second reflectivity. There might be a plurality of second code areas. On an information carrier according to the first aspect the code carrier has a first reflectivity and the second code areas have a second reflectivity, which per definition are not the same. The first reflectivity is different from the second reflectivity.

The definition that the code areas are arranged according to a predetermined regular pattern means that the code areas are positioned at regular mutual distances. By having a regular pattern, the position of a code area may be determined from the other code areas of the pattern. If for example the code pattern comprises 3×3 code areas and for some reason one of the code areas is difficult to detect, the position of that code area may still be derived from the positions of the other code areas in the code pattern. Thus, if only first code areas in the form of apertures through the sheet formed code carrier, and second code areas having a second reflectivity are used, it may be presumed that a code area which is difficult to detect at one of the positions in the 3×3 code pattern is the second code area as it is difficult for dirt to deteriorate the first code areas. Thus, the arrangement of the code areas in a predetermined pattern improves the detectability of the code pattern.

The code pattern comprises third code areas having a third reflectivity or the first reflectivity. Alternatively, the code pattern may comprise third code areas having a third reflectivity and fourth code areas having the first reflectivity. The addition of additional alternatives for the reflectivities increases the information density of the code pattern. The detectability may be slightly lower than if only the first and the second code areas are used. In case the code area has been contaminated such that the reflectivity has been changed, it might be more difficult to determine the reflectivity of the code area with a larger number of code areas. The fact that the fourth code areas have the first reflectivity means that they are indistinguishable in reflectivity from the code carrier, which also has the first reflectivity. With regard to the fourth code areas having the first reflectivity, their detectability relies on the fact that the code pattern is regular. It is also preferable that any fourth code areas having the first reflectivity are arranged in such a way that the code pattern is unambiguous. Thus, the fourth code areas should not be at the edge of the code pattern as that could make it difficult to identify the start of the code pattern.

At least one of the sheet formed code carrier and the second code areas may have a surface of a retroreflective material. In the case when the information carrier comprises a third code areas, also the third code areas may have a surface of a retroreflective material.

The retroreflective material on the surface of each one of the sheet formed code carrier and the second code areas, and the possible third code areas may comprise retroreflective spheres or retroreflective microspheres such as retroreflective glass-beads. The third code areas may alternatively comprise cube corner retroreflective material. The choice of retroreflective material for the different surfaces is preferably such as to maximize the detectability. It is possible to achieve a higher reflectivity with cube corner retroreflective material than with glass-bead retroreflective material.

As defined above the code pattern is a regular code pattern. A line between the centres of two adjacent code areas define a centre-to-centre distance. The ratio between the centre-to-centre distance between adjacent code areas and the distance between said code areas along the line defining the centre-to-centre distance is in the range 1.25-5, and preferably in the range 1.5-3. By having the defined ratio in said ranges, the detectability of the code pattern at large distances is improved. When detecting the code pattern with a LIDAR sensor the LIDAR sensor illuminates the information carrier light spots from the LIDAR sensor is incident on the information carrier. LIDAR sensors emit the divergent light such that the distance between the light spots on the information carrier increases with an increasing distance between the LIDAR sensor and the information carrier. To be able to detect a code area at least one spot should be incident on each code area and one spot should be incident on the sheet formed code carrier in the area between the code areas. To maximise the distance at which the code pattern is detectable the ratio should be approximately 2.

The code carrier may form at least a part of a self-supporting structure, such as, e.g., a cone, a cuboid, a pyramid, a triangular prism, or a cylinder. By this feature, it is possible to include information in the shape of the self-supporting structure. A cylinder may be used for a first type of information while a cone may be used for a second type of information. The code pattern may then contain more specific information on the first or second type of information. The position of the code pattern within the information carrier may also be used for the identification. Thus, in case a square information carrier is used together with a 2×2 code pattern the position of the code areas may be used to determine the code. The possibility of having different shapes of the code carrier increases the safety as both the shape and the code pattern has to be correct for the interpretation of the code.

The self-supporting structure may be collapsible. By having a collapsible structure, it is easier to transport the self-supporting structure.

The information carrier may form a continuous tape. A continuous tape is advantageous to use in cases where marking of a complex border is to be performed. A continuous tape is advantageous also in view of the portability of the information carrier as the continuous tape may be rolled into a roll.

The code areas may have a rectangular shape, which is advantageous with regard to detectability if the sensor is of a type with different resolution in different directions, such as the horizontal direction and the vertical direction. The rectangular shape is preferably adjusted to the resolution of the sensor in the corresponding directions.

The largest dimension of a code area may be in the range 10 mm to 5000 mm, preferably in the range 30 mm to 1500 mm. These are practical limits for the code areas in an information carrier according to embodiments.

According to a second aspect, a method for configuring a monitoring system is provided. The monitoring system comprises at least one LIDAR sensor, configured to record images of a monitoring area, and a computer in communication with the at least one LIDAR sensor, wherein the method comprises the steps of marking the borders of at least one monitoring zone within the monitoring area with information carriers according to the first aspect or any embodiments of the first aspect as described above in relation to the first aspect. The information carriers comprises a predetermined code pattern for each border. The method also comprises the steps of recording, with the at least one LIDAR sensor, at least one configuring image of the monitoring area with the LIDAR sensor, analysing, with the computer, the at least one configuring image to identify in the at least one configuring image the borders of the at least one monitoring zone by identifying the code pattern on the information carriers, and defining, with the computer, the at least one monitoring zone in monitoring images recorded by the at least one LIDAR sensor during monitoring of the monitoring area, based on the borders identified in the configuring image.

A method according to the second aspect provides a favourable method for configuring a monitoring zone. The configuration is easy to perform by a non-skilled person as the steps to be performed are non-complicated and do not require extensive training. The use of the information carrier according to the first aspect makes the detection of the code pattern reliable, which minimizes the risk for failure in the configuration of the code pattern.

The method may also comprise the step of relating, with the computer, each monitoring zone with at least one condition and a corresponding at least one action for each condition, wherein the monitoring system is configured, when it detects that a condition is fulfilled, to initiate the corresponding action. This facilitates the configuration of the monitoring zone.

The method may also comprise the steps of identifying the shape of the information carrier, and retrieving, from a memory, the condition related to the identified shape. This increases the information density to be transferred with only a few features on the information carrier. A condition to be fulfilled may be detection of movement of an object in a monitoring zone. A condition to be fulfilled may also comprise a speed limit to be exceeded and/or a direction interval in which the direction must be for the condition to be fulfilled.

According to a third aspect, use of an information carrier according to the first aspect or any embodiments of the first aspect, as a marker for a LIDAR sensor.

In the following, embodiments will be described with reference to the appended drawings.

### BRIEF DESCRIPTION OF THE DRAWINGS

FIG. 1 shows an information carrier for providing information to a LIDAR sensor according to a first embodiment, wherein the information carrier forms a continuous tape.

FIG. 2 shows an information carrier for providing information to a LIDAR sensor according to another embodiment, wherein the information carrier forms a part of a self-supporting structure in the form of a triangular prism.

FIG. 3 shows an information carrier for providing information to a LIDAR sensor according to another embodiment, wherein the code carrier forms a part of a self-supporting structure in the form of a cuboid.

FIG. 4 shows an information carrier for providing information to a LIDAR sensor according to another embodiment, wherein the code carrier forms a part of a self-supporting structure in the form of a cone.

FIG. 5 shows an information carrier for providing information to a LIDAR sensor according to another embodiment.

FIG. 6 shows an information carrier for providing information to a LIDAR sensor according to another embodiment.

FIG. 7 shows an information carrier for providing information to a LIDAR sensor according to another embodiment, wherein the code areas are circular.

FIG. 8 illustrates schematically a monitoring system for monitoring a monitoring area, which is to be configured with an information carrier according to the embodiments shown in FIGS. 1-7.

FIG. 9 shows a monitoring system configured for monitoring according to a second embodiment, which is to be configured with an information carrier according to the embodiments shown in FIGS. 1-7.

FIG. 10 illustrates two different methods for defining a monitoring zone.

FIG. 11 illustrates schematically a monitoring system configured for monitoring according to another embodiment.

FIG. 12 illustrates schematically a method for configuration of a monitoring system.

### DETAILED DESCRIPTION

The invention is described in the following illustrative and non-limiting detailed description of exemplary embodiments, with reference to the appended drawings. In the drawings, similar features in different drawings are denoted by the same reference numerals. The drawings are not drawn to scale.

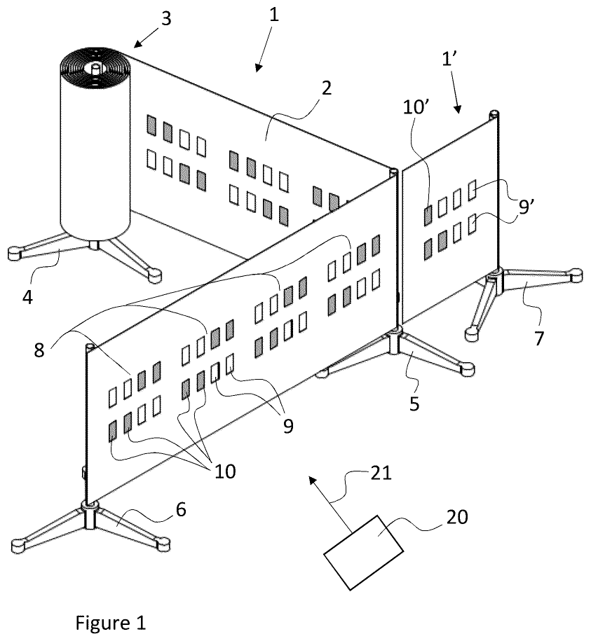

FIG. 1 shows a first information carrier 1 and a second information carrier 1′, for providing information to a LIDAR sensor 20. The first information carrier 1 comprises a first sheet formed code carrier 2 having a first reflectivity R1. The first information carrier 1 extends from a roll 3 of continuous sheet material such as, e.g., a tape. The roll 3 is arranged on a first stand 4. The first information carrier 1 extends from the roll 3 via a second stand 5 to a third stand 6, to which it is attached. The first information carrier 1 changes direction of extension at the second stand 5. The second information carrier 1′ is arranged on a fourth stand 7. The second information carrier 1′ comprises a second sheet formed code carrier 2′ having the first reflectivity R1. The second information carrier 1′ is arranged as a continuation in the direction of the first information carrier 1 between the second stand 5 and the third stand 6. The first information carrier 1 comprises four code patterns 8 on one side of the sheet formed code carrier 2′ between the second stand 5 and the third stand 6. The code patterns 8 comprises first code areas 9 in the form of apertures through the first sheet formed code carrier. The code patterns also comprises second code areas 10 having a second reflectivity R2. The code areas 9, 10, are arranged according to a predetermined pattern, which in the illustrated embodiment is in two rows and four columns. The code areas are at a distance from each other with the code carrier between the code areas 9, 10. In the embodiment illustrated in FIG. 1 all four code patterns 8 are identical and each comprises eight code patterns 8. The second information carrier 1′ comprises one code pattern 8′ with first code areas 9 in the form of apertures through the second sheet formed code carrier 2′ and second code areas 10′ having a second reflectivity R2.

As described above the first information carrier 1 and a second information carrier 1′ are configured for providing information to the LIDAR sensor 20. A LIDAR sensor detects ranges to objects in dependence of the direction as well as the reflectivity of said objects. When the LIDAR sensor 20 sends light 21 towards the code patterns 8 on the first information carrier, the light that hits the first sheet formed code carrier 2, i.e., the areas surrounding the code areas 9, 10, will result in a signal corresponding to the first reflectivity R1. The light 21 from the LIDAR sensor 20, which hits the second code areas 10, will result in a signal corresponding to the second reflectivity R2 together with the distance and direction to the first code areas. The light 21 that hits the first code areas 9 will pass the first code areas 9 and possibly be reflected in the background behind the first code areas 9. The resulting signals from the first code areas 9 will either correspond to total absorption, in case the background behind the first code areas are far away, or a different distance than the first code areas 9, in case the background is sufficiently close to the first information carrier to provide reflected light to the LIDAR sensor. Thus, the first code areas will be very easily detectable as the signal from the second code areas will be different from the signal from the second code areas, either in that no light is reflected from the first code areas or in that the light corresponding to the first code areas 9, is reflected from a different distance than the light reflected from the second code areas 10. A code pattern with eight code areas and two different code areas, as the code patterns 8 of the first information carrier 1, has 28-1 different combinations, as the combination with no apertures is not present.

As described above the code pattern 8′ of the second information carrier 1′ also comprises third code areas 11′ having a third reflectivity. By having also a third code area having a third reflectivity, the information content of the code pattern is increased. A code pattern with eight code areas and three different code areas, as the code pattern 8′ of the second information carrier 1′, has close to 3⁸ different combinations. The code pattern comprises at least one first code area, one second code area, and at least one third code area.

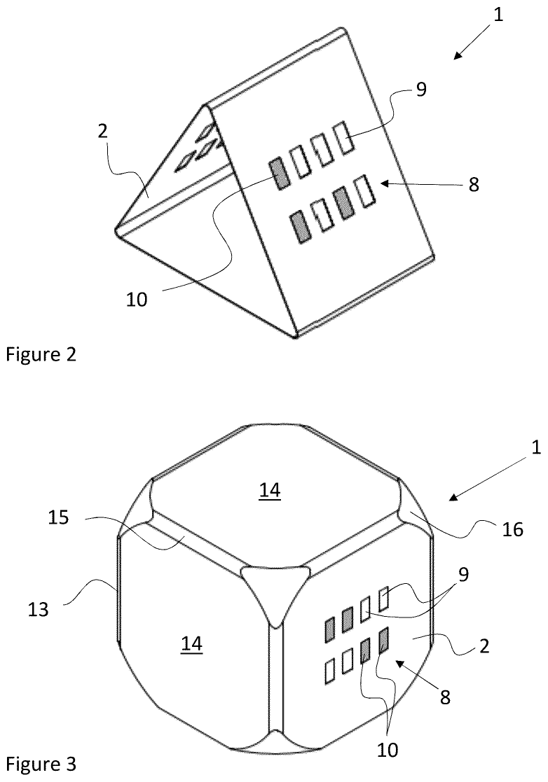

FIG. 2 shows an information carrier 1 comprising two sheet formed code carriers 2 with a code pattern 8 according to the description of the embodiment of FIG. 1, and a base 22, which together forms a self-supporting structure, in the form of a triangular prism. One of the sheet formed code carriers 2 may be detachable from the base or from the other of the sheet formed code carriers 2, such that the self-supporting structure is collapsible to a flat package. The information carrier 1 shown in FIG. 2 may be used to mark, e.g., a border to be detected by a LIDAR sensor.

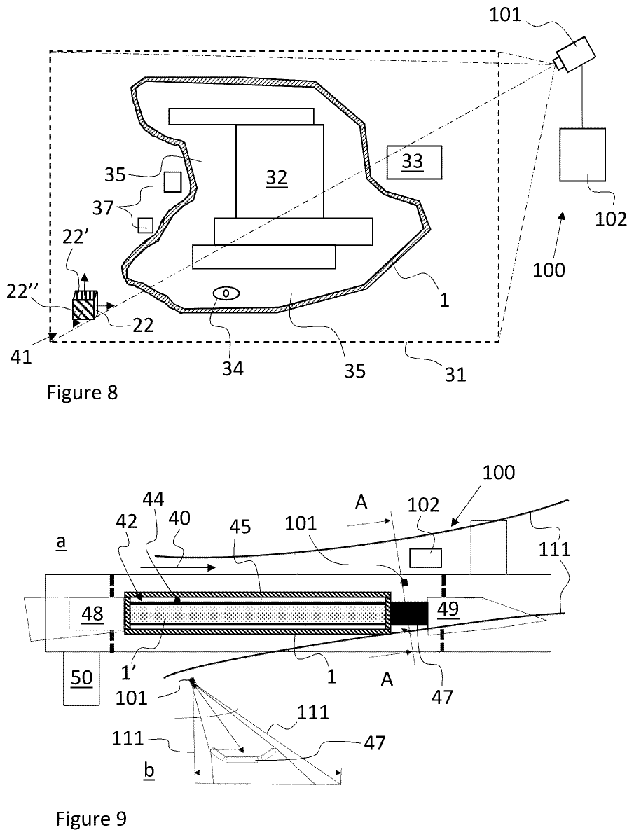

FIG. 3 shows an information carrier 1 according to another embodiment. The information carrier 1 comprises a sheet formed code carrier 2 with a code pattern 8 according to the description of the embodiment of FIG. 1 on three sides of the information carrier. The information carrier 1 also comprises a supporting structure 13, which together with the sheet formed code carrier 2 forms a cube. The cube may be configured to be collapsible. The cube may comprise detachable sides 14, edge elements 15 and corner elements 16. The information carrier according to the embodiment shown in FIG. 2 may be used to mark, e.g., a border to be detected by a LIDAR sensor. As can be seen in FIG. 3 the code patterns are different from each other. A use of such an information carrier will be described below with reference to FIG. 8.

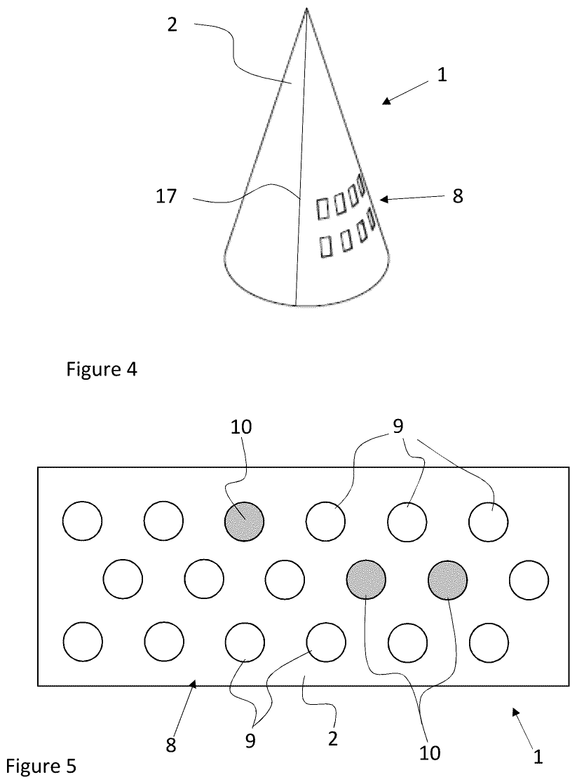

FIG. 4 shows an information carrier 1 according to another embodiment. The information carrier 1 comprises a sheet formed code carrier 2 with a code pattern 8 according to the description of the embodiment of FIG. 1. The sheet formed code carrier 2 has been rolled and attached along the attachment line 17 such that a self-supporting structure in the form of a cone has been formed. The attachment along the attachment line 17 may be provided with hook-and-loop fasteners or magnetic fasteners. The information carrier according to the embodiment shown in FIG. 2 may be used to mark, e.g., a border to be detected by a LIDAR sensor.

FIG. 5 shows schematically an information carrier 1 in the form of a sheet formed code carrier 2 having a first reflectivity R1 and comprising a code pattern 8. The code pattern 8 comprises first code areas 9 in the form of apertures through the first sheet formed code carrier 2. The code pattern also comprises second code areas 10 having a second reflectivity R2. In the embodiment of FIG. 7 the code areas 9, 10, have a circular shape and the code areas are arranged in rows, which are displaced in relation to the adjacent row(s).

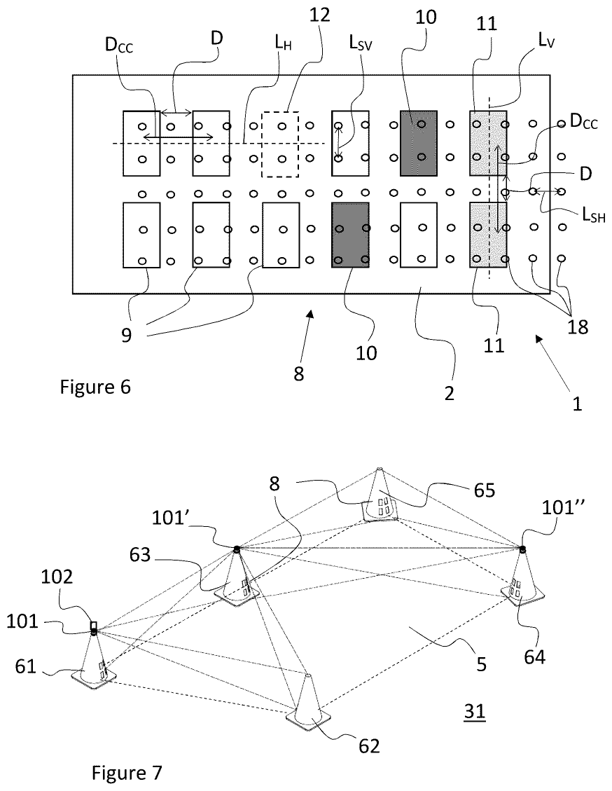

FIG. 6 shows schematically an information carrier 1 in the form of a sheet formed code carrier 2 having a first reflectivity R1 and comprising a code pattern 8. The code pattern 8 comprises first code areas 9 in the form of apertures through the first sheet formed code carrier 2. The code pattern 8 also comprises second code areas 10 having a second reflectivity R2, and third code areas 11 having a third reflectivity R3. There are two second code areas 10 which both have the second reflectivity R2 and two third code areas having the third reflectivity R3. It is understood that the first reflectivity, R1 is different from the second reflectivity R2 and the third reflectivity, and that the second reflectivity R2 is different from the third reflectivity. The code pattern 8 also comprises a fourth code area 12 having the first reflectivity R1. It should be noted that the fourth code area 12 are said to have the first reflectivity R1. This obviously means that the fourth code area has the same reflectivity as the code carrier, i.e., the background for the code pattern. The fourth code area 12 could be seen as an omitted code area but is situated in the position of a code area according to a predetermined regular pattern. In FIG. 6, the regular pattern is in the form of two rows with six code areas in each row. The spacing between adjacent code areas 9, 10, 11, 12, in a row is constant for all pairs of code areas 9, 10, 11, 12, in the row. The distance between adjacent code areas in different rows is also constant for all pairs of code areas in different rows, but may differ from the distance between code areas in the same row. This makes it possible to determine the position of the fourth code area 12 as the pattern is regular. In FIG. 6 is shown a horizontal dashed line L_{H} and a vertical dashed line L_{V} which denote the direction between centres of code areas 9, 10, wherein a line between the centres of two adjacent code areas define a centre-to-centre distance, the ratio between the centre-to-centre distance D_{CC} between adjacent code areas and the distance between said code areas along the line L_{H}, L_{V}, defining the centre-to-centre distance is in the range 1.25-5, and preferably in the range 1,5-3. Also shown in FIG. 6 is light spots 18 from a LIDAR sensor. To be able to identify the different code areas and the area between the code areas it is favourable that at least one light spot 18 is on each code area or area between the code areas 9, 10. The distance between the light spot L_{SV} in the vertical direction and the distance between the light spots in the horizontal direction L_{SH} will increase with an increasing distance between the LIDAR sensor and the information carrier. When the distance between the LIDAR sensor and the information carrier becomes large the distance L_{SV}, L_{SH}, may become too large to allow the code pattern to be detected reliably. In order to maximize the distance between the LIDAR sensor and the information carrier at which the code pattern is reliably detectable the above-defined ratio should be close to 2. The distance between the light spots may be different in the vertical direction than in the horizontal direction. To optimize the detectability the code areas may have a shape adapted accordingly, which in the embodiment of FIG. 6 means that the code areas are rectangles. The angular resolution of the LIDAR sensor varies, but is normally in the range of 0.05-0.5 degrees.

In the embodiment of FIG. 6, the sheet formed code carrier 2 has the highest reflectivity and has a surface material being a cube corner retroreflective material. The third code areas 11 has a lower reflectivity than the sheet formed code carrier 2 and have a surface material being a glass-bead retroreflective material, i.e., a material comprising retroreflective spheres. The second code areas 10 have the lowest reflectivity and have a surface material, which is not retroreflective material such as ordinary paint. The reflectivity of the paint on the second code areas 10 is lower for all angles of incidence of light.

The maximum distance at which the code pattern 8 is detectable is ultimately dependent on the size of the code areas. The largest dimension of a code area is in the range 10 mm to 5000 mm, preferably in the range 30 mm to 1500 mm. In the embodiment of FIG. 6, the largest dimension is the height of the rectangle.

FIG. 7 illustrates schematically an embodiment of a monitoring system 100 for monitoring a monitoring area 31. The monitoring area is 31 is defined by a first cone 61, a second cone 62, a third cone 63, a fourth cone 64 and a fifth cone 65. The first cone 61 comprises a first LIDAR sensor 101 at the top. The third cone 63 comprises a second LIDAR sensor 101′ at the top, and the fourth cone 64 comprises a third LIDAR sensor 101″ at the top. Each one of the cones 61-65 is similar to the cone shown in FIG. 4 and comprises at least one code pattern 8 as described in relation to FIG. 6. The at least one code pattern is turned to be detectable by the adjacent LIDAR sensor 101. Each cone 61-65 may also comprises several identical code patterns 8, such that at least one code pattern is always detectable by the LIDAR sensors 101. The monitoring system comprises at least one computer 102, which in the shown embodiment is arranged on the first cone 61. The LIDAR sensors 101 may be in radio communication with the computer 102. The borders of the monitoring zone 5 are marked with information carriers 1 in the form of the cones 61-65. Each LIDAR sensor 101, 101′, 101″, records a configuring image of the monitoring area 31 with the LIDAR sensor 101, 101′, 101″. In the embodiment of FIG. 7, the LIDAR sensors have a 360° FOV. Thus, the monitoring area 31 includes everything shown in FIG. 7.

The computer 102 receives the configuring images and analyses, the configuring images to identify in the configuring image the borders of the at least one monitoring zone 5, by identifying the code pattern 8 on the information carriers in the form of the cones 61-65. In the embodiment of FIG. 7 the first LIDAR sensor 101 is sufficiently close to the second cone 62 and the third cone 63, to be able to detect the code patterns 8 on said cones, but is too far from the fourth cone 64 and the fifth cone 65 to be able to detect the code patterns 8 on said cones. The second LIDAR sensor 101′ is sufficiently close to all other cones to detect the code pattern 8 on said cones. The third LIDAR sensor 101″ is sufficiently close to only the second cone 62, the third cone 63 and the fifth cone 65 to be able to detect the code pattern 8 on said cones.

The computer 102 defines, based on the borders identified in the configuring images, the monitoring zone 5 in monitoring images recorded by the LIDAR sensors 101, 101′, 101″ during monitoring.

FIG. 8 illustrates schematically a monitoring system 100 for monitoring a monitoring area 31, according to a second embodiment. The monitoring system 100 comprises an LIDAR sensor 101. The LIDAR sensor 101 is configured to record images of the monitoring area 31. The monitoring system 100 also comprises a computer 102 connected to the imaging device 101. An automatic machine 32 is schematically illustrated within the monitoring area 31. The automatic machine 32 is controlled by a control unit 33. In order to avoid damage to persons it is desirable to make sure that people do not come close to the automatic machine 32 when it is in operation. To this end, the monitoring system is configured to detect objects in the vicinity of the automatic machine 32, such as a person 34. During operation of the monitoring system 100, the camera continuously records images of the monitoring area 1 and sends them to the computer 102. The computer 102 analyses the recorded images to detect objects in the vicinity of the automatic machine 32.

To configure the monitoring system 100 it is necessary to define a monitoring zone 35 in which persons 34 are not allowed to be during operation of the automatic machine. When configuring the monitoring system 100, the borders of the monitoring zone 35 is marked within the monitoring area 31 with information carrier(s) 1, such as the information carrier 1 described with relation to FIG. 1. The information carrier 1 comprises a predetermined code pattern 8 (FIG. 1). In the embodiment of FIG. 8, the information carrier 1 is exemplified with a plastic tape with a code pattern as described with reference to FIG. 1. The information carrier 1 marks the border of the monitoring zone 35. As is illustrated in FIG. 1 the monitoring zone 35 may have any shape suitable for the environment as long as the monitoring system100 as a whole fulfils any regulations that might be applicable. In the embodiment of FIG. 1 the monitoring zone 35 has an irregular shape to give an operator physical access to the computer 33 and equipment 37 without having to enter the monitoring zone 35. The monitoring system 100 is configured to record, with the LIDAR sensor 101, a configuring image of the monitoring area 31. The configuring image is analyzed with the computer 102 to identify in the configuring image the borders of the monitoring zone 35, by identifying the code pattern on the information carrier 1. After having identified the border the computer 102 defines the monitoring zone 35 in monitoring images recorded by the LIDAR sensor during monitoring of the monitoring area 31, based on the borders identified in the configuring image. Thus, during subsequent monitoring of the monitoring area 31 the information carrier is not in place.

In FIG. 8 is also shown a box 41 which is used for configuring the monitoring system for Cartesian coordinates. The box comprises 6 sides of which a first side 42, a second side 42′ and a third side 42″ have different code patterns as was explained above with reference to FIG. 3. The normal to each one of said surfaces 42, 42′, and 42″, are also shown. The normal to the first side 42 defines the x-axis, the normal to the second side 42′ defines the y-axis, and the normal to the third side 42″ defines the z-axis. By arranging the box with the sides orientated in the desired directions, the monitoring system 100 may automatically configure a Cartesian coordinate system from the configuring image. This is especially useful when the LIDAR sensor is a rotating LIDAR sensor. This is due to the 3 dimensional, 3D, recording of images with the LIDAR sensor.

FIG. 9 shows a monitoring system 100 configured for monitoring according to a third embodiment. In FIG. 9, the automatic machine is a conveyor belt 47, which, during operation, runs in the direction of the arrow 40 from a loading station 48 to an unloading station 49. The LIDAR sensor 101 in FIG. 8 records a 3 dimensional image. In more detail, the LIDAR sensor sends out light in discrete directions and measures the reflected signal from each direction. The field of view, FOV, and resolution is different for different LIDAR sensors. The FOV is typically in the range of 10-90° in a first direction and 360° in the direction perpendicular to the first direction. Many different FOV exist for LIDAR sensors for different applications. LIDAR sensors for vehicle applications may have a FOV of 30° in a first direction and 120° in the direction perpendicular to the first direction. The resolution typically ranges from 0.1° to 2°. The resolution may in some LIDAR sensors be set by an operator. FIG. 9b is a cross section along A-A in FIG. 9a. The LIDAR sensor 101 has a FOV, which is illustrated by the lines 111. Within the FOV the imaging device emits light in discrete directions between the lines 111. As can be seen in FIG. 9a the distance between the lines 111 increases with an increasing distance from the LIDAR sensor 101.

The monitoring system in FIG. 9a is configured for monitoring the outer sides of the conveyor belt 47 and floor on the sides of the conveyor belt 47, to detect material that falls off the conveyor belt and that is too close to the edge 42 of the conveyor belt 47. The material could be any type of material such as, e.g., boxes or granular material. To configure the monitoring system 100 in the embodiment of FIG. 9a the monitoring zone 45 has to be defined. To define the monitoring zone 45 the borders of the monitoring zone 45 is marked with a first information carrier 1 of the type described in relation to FIG. 1, comprising a predetermined code pattern 8 (FIG. 1). The monitoring zone 45 is marked when the conveyor belt 47 is not in operation. In the embodiment of FIG. 9a, the information carrier is exemplified with a plastic tape with a code pattern as described with reference to FIG. 1. The code pattern code is illustrated as the hatching on the information carrier 1 in FIG. 9. The first information carrier 1 marks the border of the monitoring zone 45. As the central part of the conveyor belt is to be excluded from the monitoring zone the central part of the conveyor belt is covered with a second information carrier 1′ provided with a predetermined code pattern 8 (FIG. 1) which is different from the code pattern on the first information carrier 1. The code pattern on the second information carrier 1′ is illustrated by dots in FIG. 9. The monitoring system is configured to record, with the imaging device 101, a configuring image of the monitoring area 31 with the imaging device. The configuring image is analyzed with the computer to identify in the configuring image the borders of the monitoring zone 45 and to identify the area of the central part of the conveyor belt to be excluded, by identifying the predetermined code pattern associated with the first information carrier 1, and the code pattern associated with the second information carrier 1′ and the corresponding extension of the second information carrier 1′. After having identified the first information carrier 1 and the second information carrier 1′ the computer defines the monitoring zone 45 in monitoring images recorded by the imaging device during monitoring of the monitoring area 31, based on the borders identified in the configuring image. Thus, during subsequent monitoring of the monitoring area 31 the first information carrier 1 and the second information carrier 1′ are not in place. During configuration the monitoring zone 45 is related with at least one condition and a corresponding at least one action for each condition. The monitoring system 100 is also configured, when it detects that said condition is fulfilled, to initiate the corresponding action.

As an illustrating example, the conveyor belt 7 may be configured for transportation of granular material. If during operation of the conveyor belt the monitoring system 100 detects that a granule 14 is in the monitoring zone 5 the monitoring system sends a warning to, e.g., an operator. If another granule is detected within the monitoring zone 5 within a predetermined time limit, the monitoring system initiates stopping the conveyor belt. The initiation of the stopping may be done in many different ways. One alternative is that the monitoring system sends to the control unit 49 controlling the operation of the conveyor belt 47, a signal that the conveyor belt 7 should be stopped. When a subsequent granule is detected after the predetermined time limit has expired, a warning is sent again.

In an alternative embodiment, the monitoring is configured for detecting damages the edge of the conveyor belt 7. In this case, the monitoring zone (not shown) is the edge of the conveyor belt 7 and the center of the conveyor belt is covered with the sheet 13. In this embodiment, it is preferable to have an imaging device 101, which records three-dimensional images. The monitoring may, with essentially the same configuration, also be used to monitor the loading width on the conveyor belt 7.

In another alternative embodiment, the loading height on the conveyor belt 47 is monitored. In this embodiment the LIDAR sensor 101, which records three-dimensional images, is arranged as shown in FIGS. 9a and 9b. In this case, the monitoring zone is the center part of the conveyor belt 47 and the outer part of the conveyor belt 47 is marked during configuration.

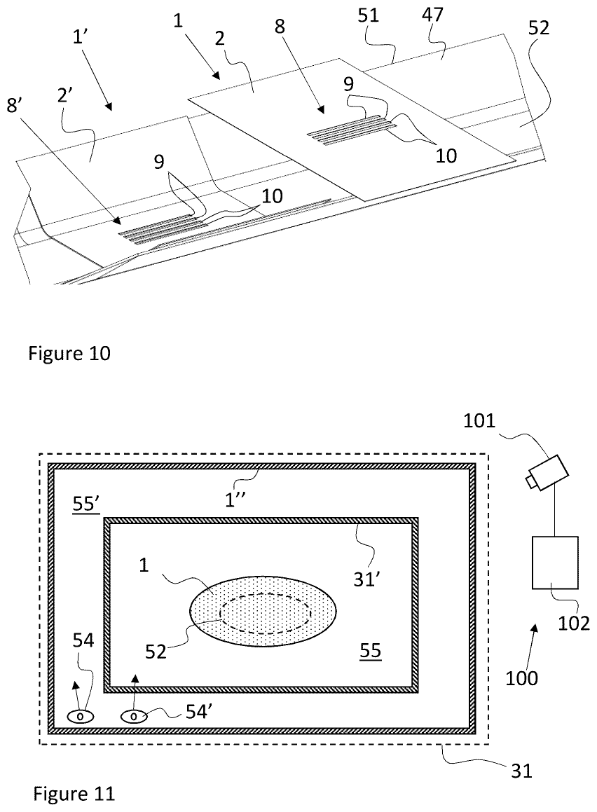

FIG. 10 illustrates two different methods for defining a monitoring zone. FIG. 10 illustrates a conveyor belt 47 similar to that described above with reference to FIG. 9. The conveyor belt 47 has a curved cross section such that the edges 51 of the conveyor belt 47 are situated above the center 52 of the conveyor belt. An information carrier 1, 1′, in the form of a sheet formed code carrier 2, 2′, is shown in two different positions. In a first position, the information carrier 1 with the code pattern 8 is resting on the edges 51 of the conveyer belt 47. In a second embodiment, the information carrier 1′ is resting on the conveyor belt 47 also in the center 52 of the conveyor belt 47. The conveyor belt is normally black rubber with low reflectivity. The information carrier has a first reflectivity R1, which is higher than the reflectivity of the conveyor belt 47. The code pattern 8, 8′, comprises first code areas 9 in the form of apertures through the first sheet formed code carrier 2 and second code areas 10 having a second reflectivity R2, which is higher than the reflectivity of the conveyor belt and different from the first reflectivity R1. In the first embodiment, the sheet formed code carrier 2 is at a larger distance from the conveyor belt. This results in that the first codes areas 9 are registered more reliably as essentially no light will be reflected back from the conveyor belt 47 through the first code areas 9.

FIG. 11 illustrates schematically a monitoring system configured for monitoring according to a third embodiment. The LIDAR sensor 101 monitors the monitoring area 31. The LIDAR sensor is connected to a computer 102 and together they form a monitoring system 100. In FIG. 11 an automatic machine 52, which may be an industrial robot, is covered by a first information carrier 1 in the form of a sheet comprising a code pattern 8 according to the embodiments described above. The first information carrier 1 excludes the area in the vicinity of the automatic machine 2 from monitoring. When configuring the monitoring system 100, the borders of a first monitoring zone 55 is marked with a second information carrier 1′, comprising a code pattern 8 (FIG. 1) facing the LIDAR sensor 101. The borders of a second monitoring zone 5′ is marked with a third information carrier 1″, comprising a predetermined code pattern 8 (FIG. 1) facing the LIDAR sensor 101. When configuring the monitoring system the monitoring zones 5, 5′, are related with at least one condition and a corresponding at least one action for each condition. In FIG. 3 a first person 54 is shown with a corresponding arrow illustrating the direction of the first person 54. A second person 54′ is shown with a corresponding arrow illustrating the direction of the second person 54′. The first person 54 as well as the second person 54′ are in the second monitoring zone 55′. The monitoring system 100 is configured to take different actions depending not only on the position of the person 54, 54′, but also the direction. The first person 54 has not a direction towards the first monitoring zone 55 and the monitoring system 100 is configured to only send a warning when such a person is detected. The second person 54′ has a direction towards the first monitoring zone 55 and the monitoring system 100 is configured to initiate stopping of the automatic machine when such a person is detected. The monitoring system 100 is configured to initiate stopping of the automatic machine 52 when a person is detected within the first monitoring zone 55.

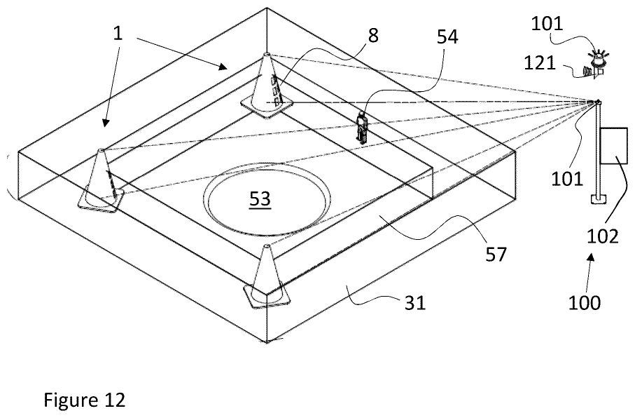

FIG. 12 illustrates schematically a method for configuration of a monitoring system. The LIDAR sensor is connected to a computer 102 and together they form a monitoring system 100. The LIDAR sensor 101 monitors the monitoring area 31. The LIDAR sensor 101 detects the information carriers 1 and the code pattern 8 on the information carriers 1. By detection of the shape of the information carriers 1 as cones and by interpreting the code pattern 8, the computer 102 of the monitoring system 100 determines the warning area 57. After configuration of the monitoring system 100, the information carriers 1 may be removed. When a person 54 enters the warning area 57, the monitoring system 100 detects this and alert the person by sending out a sound and light signal via the lamp 120 and the speaker 121. In this way the person is alerted and the person may avoid walking into the hole 53.

The above-described embodiments may be altered in many ways without departing from the scope of the invention, which is limited only by means of the appended claims and their limitations.

1. Information carrier for providing information to a LIDAR sensor, the information carrier comprising:
a sheet formed code carrier having a first reflectivity, and
at least one code pattern on a part of one side of the sheet formed code carrier, characterized in that wherein the code pattern comprises:
first code areas in the form of apertures through the sheet formed code carrier, and
second code areas having a surface of a retroreflective material with a second reflectivity, wherein the first reflectivity is different from the second reflectivity, wherein the code areas are arranged according to a predetermined regular pattern, and wherein the code areas are at a distance from each other with areas of the sheet formed code carrier between the code areas.

2. The information carrier according to claim 1, wherein the code pattern comprises third code areas having a third reflectivity or the first reflectivity, wherein the third reflectivity is different from the first reflectivity and the third reflectivity is different from the second reflectivity.

3. The information carrier according to claim 1, wherein the code pattern comprises third code areas having a third reflectivity and fourth code areas having the first reflectivity, and wherein the third reflectivity is different from the first reflectivity and the third reflectivity is different from the second reflectivity.

4. The information carrier according to claim 1, wherein at least one of the sheet formed code carrier and the second code areas has a surface of a retroreflective material.

5. The information carrier according to claim 2, wherein at least one of the sheet formed code carrier, the second code areas, and the third code areas has a surface of a retroreflective material.

6. The information carrier according to claim 4, wherein the retroreflective material on the surface of each one of the sheet formed code carrier and the second code areas comprise retroreflective spheres, such as retroreflective glass-beads, or is a cube corner retroreflective material.

7. The information carrier according to claim 5, wherein the retroreflective material on the surface of each one of the sheet formed code carrier, the second code areas and the third code areas comprise retroreflective spheres, such as retroreflective glass-beads, or is a cube corner retroreflective material.

8. The information carrier according to claim 1, wherein a line between the centres of two adjacent code areas define a centre-to-centre distance, wherein the ratio between the centre-to-centre distance between adjacent code areas and the distance between said code areas along the line defining the centre-to-centre distance is in the range 1.25-5, and preferably in the range 1,5-3.

9. The information carrier according to claim 1, wherein the information carrier forms at least a part of a self-supporting structure.

10. The information carrier according to claim 9, wherein the self-supporting structure is collapsible.

11. The information carrier according to claim 1, wherein the information carrier forms a continuous tape.

12. The information carrier according to claim 1, wherein the code areas have a rectangular shape.

13. The information carrier according to claim 1, wherein the largest dimension of a code area is in the range 10 mm to 5000 mm, preferably in the range 30 mm to 1500 mm.

14. A method for configuring a monitoring system, wherein the monitoring system comprises at least one LIDAR sensor, configured to record images of a monitoring area, and a computer in communication with the at least one LIDAR sensor, wherein the method comprises the steps of:
marking the borders of at least one monitoring zone within the monitoring area with information carriers according to claim 1, comprising a predetermined code pattern for each border,
recording, with the at least one LIDAR sensor, at least one configuring image of the monitoring area with the LIDAR sensor,
analysing, with the computer, the at least one configuring image to identify in the at least one configuring image the borders of the at least one monitoring zone by identifying the code pattern on the information carriers, and
defining, with the computer, the at least one monitoring zone in monitoring images recorded by the at least one LIDAR sensor during monitoring of the monitoring area, based on the borders identified in the configuring image.

15. The method according to claim 14, wherein the method also comprises the step of relating, with the computer, each monitoring zone with at least one condition and a corresponding at least one action for each condition, wherein the monitoring system is configured, when it detects that a condition is fulfilled, to initiate the corresponding action.

16. The method according to claim 15, also comprising the steps of
identifying the shape of the information carrier, and
retrieving, from a memory, the condition related to the identified shape.

17. The method according to claim 15, wherein a condition to be fulfilled is detection of movement of an object in a monitoring zone.

18. The method according to claim 17, wherein a condition to be fulfilled also comprises a speed limit to be exceeded and/or a direction interval in which the direction must be for the condition to be fulfilled.

19. Use of the information carrier according to claim 1, as a marker for a LIDAR sensor.
